(19) United States
(12) Patent Application Publication
(10) Pub. No.: US 2016/0364466 A1
(43) Pub. Date: Dec. 15, 2016

(54) METHODS AND APPARATUS FOR ENHANCED DATA STORAGE BASED ON ANALYSIS OF DATA TYPE AND DOMAIN

(71) Applicant: The Medical College of Wisconsin, Inc., Milwaukee, WI (US)

(72) Inventors: Arthur Michael WEBORG, JR., Kewaunee, WI (US); Brandon Michael WILK, Hartford, WI (US); Elizabeth Anabel WORTHEY, Germantown, WI (US)

(73) Assignee: THE MEDICAL COLLEGE OF WISCONSIN, INC., Milwaukee, WI (US)

(21) Appl. No.: 14/739,816

(22) Filed: Jun. 15, 2015

(51) Int. Cl. G06F 17/30

(52) U.S. Cl. CPC G06F 17/30598; G06F 17/30292

(57) ABSTRACT

In some embodiments, an apparatus includes a data management module implemented in at least one of a memory or a processor. The data management module is configured to associate a different classification parameter with each data set from a set of data sets stored in the memory. The data management module is configured to store, in a first data set and using a first storage scheme based on a type of the classification parameter of the first data set, a set of values. Each value is associated with a different object. The data management module is configured to store, in a second data set and using a second storage scheme different from the first storage scheme and based on a type of the classification parameter of the second data set, a set of values. Each value is associated with a different object.

### BACKGROUND

Some embodiments described herein relate generally to data management, and in particular, to methods and apparatus for improved data storage based on data type and domain.

There is a growing demand for quickly and efficiently storing and accessing a large volume of electronic data. Data compression tools are often used to save storage space, reduce footprint of data, and support for more rapid and efficient analysis or access of such data. For example, genomic sequencing data can be stored in Microsoft Excel files, which can then be stored in a computer memory. Such an Excel file can often take up large amounts of storage space. Moreover, it can often take a few hours to open a Microsoft Excel file with genomic sequencing data and search for a specific genomic sequence object in the Microsoft Excel file.

Accordingly, a need exists for methods and apparatus for an improved data storage technique such that a large volume of data (such as genomic data) can be stored, accessed, analyzed quickly.

### SUMMARY

In some embodiments, an apparatus includes a data management module implemented in at least one of a memory or a processor. The data management module is configured to associate a different classification parameter from a set of classification parameters with each data set from a set of data sets stored in the memory. The data management module is configured to store, in a first data set from the set of data sets and using a first storage scheme based on a type of the classification parameter of the first data set, a set of values for the classification parameter of the first data set. Each value from the set of values for the classification parameter of the first data set is associated with a different object from a set of objects. The data management module is configured to store, in a second data set from the set of data sets and using a second storage scheme different from the first storage scheme and based on a type of the classification parameter of the second data set, a set of values for the classification parameter of the second data set. Each value from the set of values for the classification parameter of the second data set is associated with a different object from the set of objects.

### BRIEF DESCRIPTION OF THE DRAWINGS

FIG. 1 is a schematic diagram that illustrates a data management system, according to an embodiment.

FIG. 2 is a schematic diagram that illustrates a data management module, according to an embodiment.

FIG. 3 is a diagram that illustrates an example data storage structure, according to an embodiment.

FIGS. 4A-4C are diagrams illustrating binary structures in a form of arrays implemented by a data management system, according to an embodiment.

FIGS. 5A-5B are diagrams illustrating binary structures in a form of heap arrays implemented by a data management system, according to an embodiment.

FIG. 6 is a diagram illustrating an object mapping storage structure implemented by a data management system, according to an embodiment.

FIGS. 7A-7C are diagrams illustrating another object mapping storage structure implemented by a data management system, according to an embodiment.

FIG. 8 is a diagram illustrating a curative data handling binary structure data access for a given object in a test DNA sequence, according to an embodiment.

FIG. 9A is a diagram illustrating a data structure for multiple records, according to an embodiment.

FIG. 9B is a diagram illustrating a data structure for multiple records, according to an embodiment

FIG. 10 is a flow chart illustrating a data management method, according to an embodiment.

### DETAILED DESCRIPTION

Methods and apparatus for improved data storage based on data type and domain are described herein. In some embodiments, an apparatus includes a data management module implemented in at least one of a memory or a processor. The data management module is configured to associate a different classification parameter from a set of classification parameters with each data set from a set of data sets stored in the memory. The data management module is configured to store, in a first data set from the set of data sets and using a first storage scheme based on a type of the classification parameter of the first data set, a set of values for the classification parameter of the first data set. Each value from the set of values for the classification parameter of the first data set is associated with a different object from a set of objects. The data management module is configured to store, in a second data set from the set of data sets and using a second storage scheme different from the first storage scheme and based on a type of the classification parameter of the second data set, a set of values for the classification parameter of the second data set. Each value from the set of values for the classification parameter of the second data set is associated with a different object from the set of objects.

In some embodiments, an apparatus includes a data management module implemented in at least one of a memory or a processor. The data management module is configured to associate a different classification parameter from a set of classification parameters with each data set from a set of data sets stored in a database. The data management module is configured to store, in a first data set from the set of data sets, a set of values for the classification parameter of the first data set. Each value from the set of values for the classification parameter of the first data set is associated with a different object from a set of objects. The data management module is configured to store, in a second data set from the set of data sets, a set of values for the classification parameter of the second data set. Each value from the set of values for the classification parameter of the second data set is associated with a different object from the set of objects. An order in the first data set of the value associated with each object from the set of objects is the same as an order in the second data set of the value associated with that object from the set of objects.

In some embodiments, a non-transitory processor-readable medium stores code representing instructions to be executed by a processor. The code includes code to cause the processor to associate a different classification parameter from a set of classification parameters with each data set from a set of data sets. The code includes code to cause the processor to store, in a first data set from the set of data sets and using a first storage scheme based on a type of the classification parameter of the first data set, a set of values for the classification parameter of the first data set. Each value from the set of values for the classification parameter of the first data set is associated with a different object from a set of objects. The code includes code to cause the processor to store, in a second data set from the set of data sets and using a second storage scheme based on a type of the classification parameter of the second data set, a set of values for the classification parameter of the second data set. Each value from the set of values for the classification parameter of the second data set is associated with a different object from the set of objects.

As used herein, a module can be, for example, any assembly, instructions and/or set of operatively-coupled electrical components, and can include, for example, a memory, a processor, electrical traces, optical connectors, software (executing in hardware) and/or the like.

As used in this specification, the singular forms “a,” “an” and “the” include plural referents unless the context clearly dictates otherwise. Thus, for example, the term “a data set” is intended to mean a single data set or multiple data sets. For another example, the term “a classification parameter” can mean a single classification parameter or multiple classification parameters.

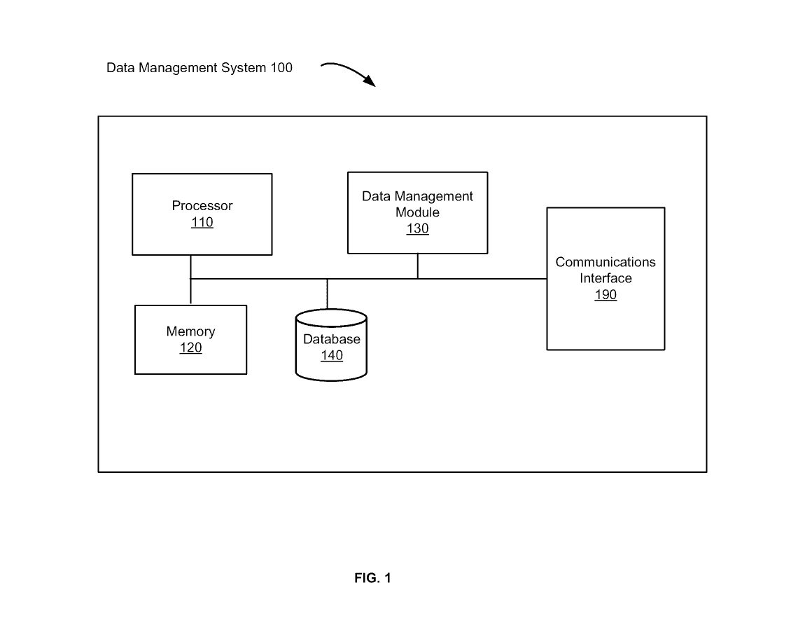

FIG. 1 is a schematic diagram that illustrates a data management system 100, according to an embodiment. A system and processes to provide improved data storage based on data type and domain that allow fast data access is described with respect to FIG. 1. FIG. 1 is an architectural diagram, and therefore certain details are intentionally omitted to improve the clarity of the description.

As shown in FIG. 1, the data management system 100 includes a processor 110, a memory 120, a database 140, a communications interface 190, and a data management module 130. In some embodiments, the data management system 100 can be a single physical device. In other embodiments, the data management system 100 can include multiple physical devices (e.g., operatively coupled by a network), each of which can include one or multiple modules and/or components shown in FIG. 1.

Each module or component in the data management system 100 can be operatively coupled to each remaining module and/or component. Each module and/or component in the data management system 100 can be any combination of hardware and/or software (stored and/or executing in hardware) capable of performing one or more specific functions associated with that module and/or component.

The memory 120 can be, for example, a random-access memory (RAM) (e.g., a dynamic RAM, a static RAM), a flash memory, a removable memory, a hard drive, a database and/or so forth. In some embodiments, the memory 120 can include, for example, a database, process, application, virtual machine, and/or some other software modules (stored and/or executing in hardware) or hardware modules configured to execute a data management process and/or one or more associated methods for data management (e.g., via the data management module 130). In such embodiments, instructions of executing the data management process and/or the associated methods can be stored within the memory 120 and executed at the processor 110. In some embodiments, data can be stored in a database 140 and/or in the memory 120.

The communications interface 190 can include and/or be configured to manage one or multiple ports of the data management system 100. In some instances, for example, the communications interface 190 (e.g., a Network Interface Card (NIC)) can include one or more line cards, each of which can include one or more ports (operatively) coupled to devices (e.g., user input devices not shown in FIG. 1). A port included in the communications interface 190 can be any entity that can actively communicate with a coupled device or over a network (e.g., communicate with end-user devices, host devices, servers, etc.). In some embodiments, such a port need not necessarily be a hardware port, but can be a virtual port or a port defined by software. The communication network can be any network or combination of networks capable of transmitting information (e.g., data and/or signals) and can include, for example, a telephone network, an Ethernet network, a fiber-optic network, a wireless network, and/or a cellular network. The communication can be over a network such as, for example, a Wi-Fi or wireless local area network (“WLAN”) connection, a wireless wide area network (“WWAN”) connection, and/or a cellular connection. A network connection can be a wired connection such as, for example, an Ethernet connection, a digital subscription line (“DSL”) connection, a broadband coaxial connection, and/or a fiber-optic connection. For example, the data management system 100 can be a host device configured to be accessed by one or more compute devices (not shown) via a network. In such a manner, the compute devices can provide information to and/or receive information from the data management system 100 via the network. Such information can be, for example, information for the data management system 100 to analyze, compress and/or store as described in further detail herein. Similarly, the compute devices can be configured to retrieve and/or request stored information from the data management system 100.

In some embodiments, the communications interface 190 can include and/or be configured to include input/output interfaces. The input/output interfaces may accept, communicate, and/or connect to user input devices, peripheral devices, cryptographic processor devices, and/or the like. In some instances, one output device can be a video display, which can include, for example, a Cathode Ray Tube (CRT) or Liquid Crystal Display (LCD), LED, or plasma based monitor with an interface (e.g., Digital Visual Interface (DVI) circuitry and cable) that accepts signals from a video interface. In such embodiments, the communications interface 190 can be configured to, among other functions, receive data and/or information, and send data management modifications, commands, and/or instructions.

The database 140 can be a fault tolerant, relational, scalable, and/or secure database. The database 140 can store the data to be processed by the data management module 130. The database 140 can be within the memory 120 or within a separate storage medium. The database 140 can be structured to include multiple data sets that collectively store multiple objects as described in further details herein.

The processor 110 can be configured to control, for example, the operations of the communications interface 190, write data into and read data from the memory 120 and/or the database 140, and execute the instructions stored within the memory 120. The processor 110 can also be configured to execute and/or control, for example, the operations of the data management module 130, as described in further detail herein. In some embodiments, under the control of the processor 110 and based on the methods or processes stored within the memory 120, the data management module 130 can be configured to execute a data management process, as described in further detail herein.

The data management module 130 can be any hardware and/or software module (stored in a memory such as the memory 120 and/or executing in hardware such as the processor 110) configured to classify data (i.e., objects) with data type and domain and store data using a storage scheme based on data domain and data range. In some embodiments, the data management module 130 is implemented in the memory 120 or the processor 110. For example, The data management module 130 analyzes content of a set of objects and classifies each object into a set of values based on data domain and data range. The data domain includes at least one of numbers, dates, strings, and/or the like. The data range is a total number of bits used to store a specific value within a specific data domain. The values of the same data domain from the set of objects are stored in a data set associated with a classification parameter. The data management module 130 collectively stores in the set of data sets a set of values for each object from the set of objects based on the set of classification parameters, as described in further detail herein. The objects can include, for example, genomic sequences, medical records, student records, legal contracts, financial data, geographic maps and/or the like.

In some embodiments, the objects in each data set maintain the same order. In other words, an order of a value of a particular object in a first data set is the same as an order of a value of the particular object in a second data set. Therefore, when an order of a particular object in a data set is known, the same order can be used to index search for the particular object in other data sets.

For example, to store and access student records, the data management module 130 analyzes the content of the student records data and associates a classification parameter (e.g., student name, student identification number, student birth date, and/or the like) with each value of a student record. For each classification parameter, the data management module 130 can determine a minimum number of bits and a maximum number of bits to represent the values. The data management module 130 can subsequently store values associated with each classification parameter in a separate data set. For example, the values for student name of each student can be stored in a first data set, and the values for student ID of each student can be stored in a second data set. The number of bits associated with each value for each object in a data set can be fixed and the number bits associated with each value for the same object in different data sets may be different. In some embodiments, an order of the set of objects in the data sets can be maintained across the data sets. Therefore, when an order (e.g., number 3 out of 100 students) of a particular object (e.g., student A) in a data set (e.g., student ID) is known, the same order (e.g., number 3 out of 100 students) can be used to index search for the particular object (e.g., student A) in other data sets (e.g., student name, student birth date, etc.), as described in further detail herein.

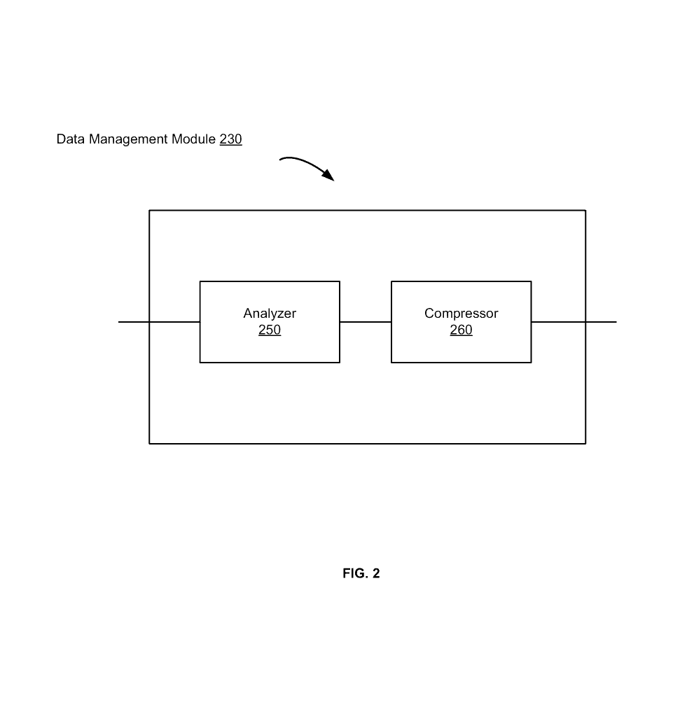

FIG. 2 is a schematic diagram that illustrates a data management module, according to an embodiment. The data management module 230 can be structurally and functionally similar to the data management module 130 shown and described with respect to FIG. 1. The data management module 230 includes an analyzer 250 and a compressor 260. The analyzer 250 analyzes content of a set of objects and classifies each object into a set of values based on the data domain and the data range. For example, based on the content of annotations of genomic sequence, the analyzer can classify values into number type, date type, string type, map type, accommodation of different types, and/or the like. For each data type, the analyzer can determine a data range of the values associated with the annotations.

The compressor 260 compiles the values with the same data domain from the set of objects in a data set associated with a classification parameter. Using the data domain (i.e., data type) and data range, the compressor 260 can efficiently store the values. Similarly stated, using the data domain the compressor 260 can select an improved and/or optimum way to store the data and using the data range (with a storage scheme and definition of the storage scheme), the compressor 260 can reduce the amount of storage (e.g., bits, bytes, etc.) used to store the data set.

For example, a first data set associated with a classification parameter of “cell type” can store the names of the cells from which the genomic sequencing is performed. The analyzer 250 determines that the names of the cells are string type data, and that the maximum number of bits used to store the names of the cells is 8 bits. The compressor 260 subsequently stores the names of the cells in the first data set in a storage scheme where 8 bits of storage space are reserved for each value. A second data set associated with a classification parameter of “number of genes” can store the number of genes associated with each cell from which the genomic sequencing is performed. The analyzer 250 determines that the numbers of genes are number type data, and that the maximum number of bits used to store the numbers of genes is 5 bits. The compressor 260 subsequently stores the numbers of genes in the second data set in a storage scheme where 5 bits of storage space are reserved for each value. In some embodiments, an order of the names of the cells associated with each genomic sequence in the first data set is the same as an order of the number of genes associated with the same genomic sequence in the second data set. The data management module 230 collectively store in the set of data sets a set of values for each object from the set of objects based on the set of classification parameters.

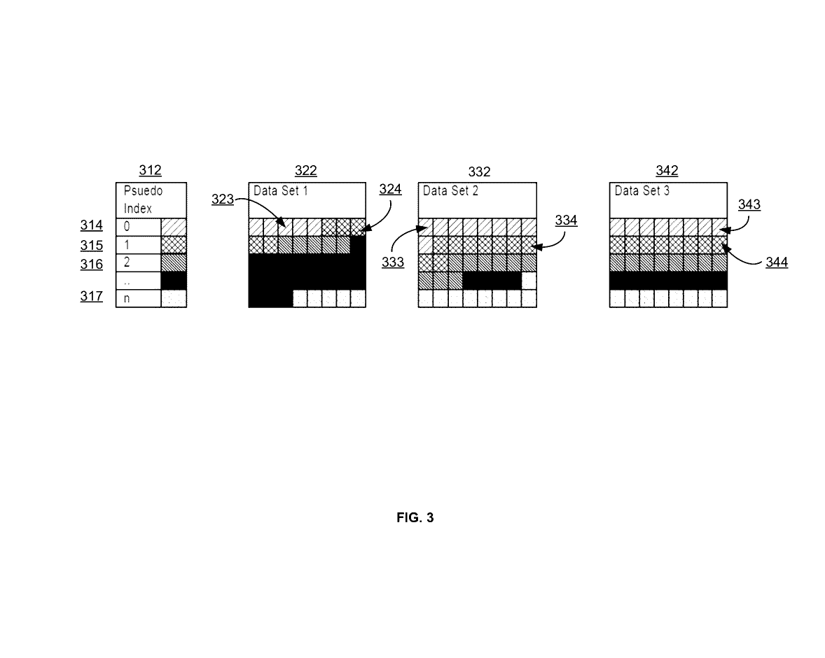

FIG. 3 is a diagram that illustrates an example data storage structure, according to an embodiment. In some embodiments, a compressor in a data management system assigns a pseudo index 312 to each object. The data management system is structurally and functionally similar to the data management system 100 shown and described with respect to FIG. 1. The compressor is structurally and functionally similar to the compressor 260 shown and described with respect to FIG. 2. For example, object 0, 314, has a pseudo index of 0, object 1, 315, has a pseudo index of 1, object 2, 316, has a pseudo index of 2, object n, 317, has a pseudo index of n, and so on. The pseudo index 312 is used to seek, crawl, and/or map into data sets associated with objects. In some embodiments, the pseudo index 312 is not stored and/or does not exist in a memory. In such embodiments, the pseudo index 312 is used here for illustration purpose. In other embodiments, the pseudo index 312 is stored in a memory.

An analyzer in the data management system analyzes content of a set of objects (e.g., 314-317) and classifies each object into a set of values based on data domain and data range. The analyzer is structurally and functionally similar to the analyzer 250 shown and described with respect to FIG. 2. The values of the same data domain from the set of objects are stored in a common data set associated with a classification parameter and using a common storage scheme. Each of the data set 1, 322, Data set 2, 332, and data set 3, 342, is associated with a different classification parameter and associated with a different storage scheme tailored to that classification parameter. In this example, each cell in the data sets represents a byte of data. In this example, each object includes three data domains, and therefore, the values of each object are stored in three data sets. Data set 1 is associated with a classification parameter and the number of bytes available to store the value of that classification parameter for each object in data set 1 is 5 bytes. Object 0 has 5 bytes of storage space 323 available in data set 1 to store the value of that classification parameter for object 0. Similarly, object 1 has 5 bytes of storage space 324 available in data set 1 to store the value of that classification parameter for object 1. Moreover, object 0 has 9 bytes of storage space 333 available in data set 2 to store the value of that classification parameter associated with data set 2 for object 0. Similarly, object 1 has 9 bytes of storage space 334 available in data set 2 to store the value of that classification parameter for object 1. Object 0 has 8 bytes of storage space 343 available in data set 3 to store the value of that classification parameter associated with data set 3 for object 0. Similarly, object 1 has 8 bytes of storage space 344 available in data set 3 to store the value of that classification parameter for object 1. Objects, from object 0 to object n, maintain the same order in the data sets 322, 332, 342 as in the pseudo index 312, which allows index seeking, index crawling, and/or index mapping of the data. For example, if the order of object 1 is known, which is the 2^{nd} of the objects, the values at the 2^{nd} object in the data sets can be accessed and retrieved.

For example, the data management system can assign a pseudo index 312 to objects in student records data. Each object represents record of a student. The analyzer in the data management system analyzes the content of the student record data and associates a classification parameter with each value. Data set 1 can be configured to store student identification numbers, data set 2 can be configured to store student names, and data set 3 can be configured to store student birth dates. Based on the data range of data associated with each classification parameter, the compressor in the data management system can allocate 5 bytes of storage space to the student identification numbers 322, 9 bytes of storage space to the student names 332, and 8 bytes of storage space 343 to the student birth dates. The order of the values associated with the students in the data sets is the same as the order in the pseudo index 312. Thus, when the information for the student associated with object 0 is accessed, data management module can retrieve the first value in each of the data sets (i.e., the first 5 bytes in data set 1, the first 9 bytes in data set 2, and the first 8 bytes in data set 3). In such a manner, the student's identification number, name and birth date can be retrieved.

In some embodiments, when data are numbers, a meta-attribute of a minimum and maximum can be determined by the analyzer and included in a definition of the storage scheme for the associated classification parameter. From these minimum and maximum values, the total number of bits used to store the specific values within the set of annotations can be determined by the analyzer. For example, an offset value can be assigned if the values range from 100-200. As such, the value “100” can be stored as “0” and the value “200” can be stored as “100”. When the data is retrieved, an offset of 100 can be added to the retrieved value. Such an offset value can be stored as part of the definition of the storage scheme associated with the dataset. This allows the values to be stored using a smaller amount of memory. In other embodiments, any other suitable offset, mapping and/or calculation can be used and stored within the definition of the storage scheme to reduce the amount of memory used to store the data for a data set. In some embodiments, outlier meta-attribute values (i.e., outside the normal range of minimum and maximum values) can be assigned. These values can remove the range (i.e., the minimum and maximum) and/or the offset value and therefore increase the meta-attribute min value and decrease the meta-attribute max value. In other embodiments, unique or special meta-attribute values outside of the minimum and/or maximum values such as not applicable (NA) can be assigned.

In some embodiments, integers can be represented in a data set. In some embodiments, for example, the data, in a lossless manner, is transformed into a set of positive integers. For example, a meta-attribute minimum of zero can be established and a meta-attribute maximum value in the set can be established. The total number of bits used to store each value in the annotation can be determined by this maximum number. In some embodiments, for example, annotation sets have values of “not applicable” for a location in a DNA sequence. In the “not applicable” circumstance and other special situations a value is mapped to represent an “NA” or the special value. These mapped values will fall outside of the determined range, but within the possible values for a given number of bits. When the values can be included in the set of Integers, Z,

ANNOTATION_SET={x|xεZ,min≦x≦max}

Whether or not an array of bits accounts for a sign value (positive and negative values) can be determined. Based on the signed factor the largest absolute value between minimum and maximum is used to determine the total number of bits that is used to store each value in the data set (e.g., each stored annotation). In such embodiments, an offset value (as described above) can be used to represent the offset in the definition of the storage scheme. When “Not Applicable” or special values need to be applied:

ANNOTATION_SET={x|xεZ,min≦x≦max}U{“Not Applicable”,SPECIAL_VALUE_1,SPECIAL_VALUE_2, . . . ,SPECIAL_VALUE_N}

For a set of annotations A, which are integer typed domain annotations:

A={x|xεZ,0≦x≦100}U{“Not Applicable”}

The min value can be 0, and the max value can be 100. To store integer values from 0 to 100 an unsigned 7-bit integer can be configured. Values from 0 to 128 can be stored. A value of 101 can be assigned to “Not Applicable”.

In some embodiments, for representing floating point domain numbers (e.g., DNA annotations such as population frequencies), a precision meta-attribute can be assigned and stored in the definition of the storage scheme associated with the data set. After the decision on this precision attribute is made, the values for the data set are passed through a function to produce a given set of integer values. These values can be passed through an inversed function while being decompressed. For a set of annotations B:

B={x|xε [symbol] ,0≦x≦100}U{“Not Applicable”}

During the analysis of this set, it was determined that a precision of two decimal places is to be used. Set B would be applied to a function to produce set C:

C={x|xεZ,0≦x≦10000}U{“Not Applicable”}

The new set C is treated similarly as the previous integer field. The minimum and maximum values can be 0 and 10000 respectively. To store integer values from 0 to 10000 an unsigned 14-bit integer can be used. Values from 0 to 16383 can be stored. A value of 10001 can be mapped to “Not Applicable”. In this manner, values from 0.00 to 100.00 can be stored. Each value can be multiplied by 100 when storing the value and each value can be divided by 100 when retrieving the value from the data set. Such an offset can be stored in the definition of the storage scheme associated with the data set.

When data are dates or similar to dates, during the analysis of the data by the analyzer, the values can be analyzed as time in milliseconds from the epoch date. These millisecond values (numbers) can be treated similar to the number types described above. Additionally, since often the exact hours, minutes, seconds, and milliseconds are not used, dates can also be given a precision meta-attribute, similar to the floating point domain numbers. Using this precision meta-attribute method, dates can have several bits truncated in storage and amplified back without loss of precision. For example, in some instances the date is precise down to the day. This allows for the original date in milliseconds to be reduced from 32 bits down to 16 bits, by a factor of 86,400,000 (milliseconds per day). In some embodiments, milliseconds can be truncated from a time stamp. This can decrease the bit size by 3 bits, or by a factor of 1000. A meta-attribute of precision thus can be applied to date typed data domain (and stored in the storage scheme definition for that data set.

For another example, Thursday Jun. 11, 2015 at 9:25:20.121 AM can be represented by the following millisecond value in JavaScript: 1434032720121. If the date is precise down to seconds, this number can be represented by 1434032720000 in a standard format. This is equivalent to Thursday Jun. 11, 2015 at 9:25:20 am. This number can be reduced down by a factor of 1000 (the millisecond precision). Therefore in storage this number is 1434032720. To display the date accurately before use in code, this number can be multiplied by 1000 to return to 1434032720000.

Taking the same example, if the date is precise down to minutes. The number can be represented by 1434032700000 in the standard format. This is equivalent to Thursday Jun. 11th, 2015 at 9:25 am. This number can be reduced down by a factor of 60000 (60 seconds*1000 milliseconds). So in storage this number can be 23900545. To display this date accurately before use in code, this number can be multiplied by 60000 to return to 1434032700000.

Taking the same example, if the date is precise down to the day. The number can be represented by 1433980800000 in the standard format. This is equivalent to Thursday Jun. 11th, 2015. This number can be reduced down by a factor of 86400000 (24 hours*60 minutes*60 seconds*1000 milliseconds). Therefore in storage this number is 16597. To display the date accurately before use in code, this number can be multiplied by 86400000 to return to 1433980800000. This allows to save storage space if a date is to be precise down to seconds, minutes, hours, or days.

In some embodiments, dates type of data can be represented as combinations of strings and/or numbers. In other embodiments, dates can be represented as long integers. The date can be expressed as a long integer, milliseconds since (or prior to) Epoch time.

ANNOTATION_SET={x|xεZ,0≦x≦CURRENT_TIME_IN_MS}

When there exists a relatively small number of unique values in a given set of data, a mapping can be derived during data analysis by the analyzer. The meta-mapping changes from the specific type (e.g., a character or string) to an integer value. This integer value can increment in size starting from 0 and can then undergo the same compression technique as applied to the number type of data to determine the number of bits to use.

Like the number typed annotations, an analysis is performed on annotations that appear to belong to a finite set of potential values. From this analysis, the set of annotated values can be identified and each value can be assigned a pseudo index. In some embodiments, there exists a one-to-one surjection; a bijection, between mapped or finite sets of data. Each unique set value can be indexed. This allows for the definition of two sets, one of indexes (e.g., stored in the definition of the storage scheme) and the other of set values. Set A contains the indexes and set B contains the values:

A={x|xεZ,0≦x≦N},

B={VALUE_1,VALUE_2, . . . ,VALUE_N}

Where there exists a Bijection between set A and set B.

In some embodiments, the mapping between the index and the annotated value is defined upon completion of the domain analysis and stored in the definition of the storage scheme. The meta-attribute mapping is used as schema, and the indexes are the values being turned to bit-integers and stored. In some embodiments, there exists a set B:

B={“BENIGN”,“DAMAGING”,“UNKNOWN”}

Set A is defined as:

A={0,1,2}

Similar to the integer typed annotations, a min value of 0, and a max value of 2 can be determined. An unsigned 2-bit integer is needed to store integer values from 0 to 2. The mapping between set A and set B can be stored in the storage scheme for that data set. Set A can then be stored in the memory and mapped to set B when decompressed. The appropriate value in set B can then be provided (e.g., to a user) when retrieving the data.

In some embodiments, the data management module can be configured to provide filtering functions when retrieving data from data sets. In the above example, the data management module can construct filtering options for data set B as “Benign”, “Damaging” and/or “Unknown”: An end user can choose to filter out “Benign” and “Unknown” and include only “Damaging”. The data management module can, based on the bijection between set A and set B, filter the compressed data to return objects that have a value of 1 from set A.

In some embodiments, there still exists a bijection between set A and set B. There are 0 to many annotations given to a target DNA sequence as opposed to the one to one relationship for the annotation set to the DNA sequence from the previous example. An underlying data structure with dynamically sized segments can be used. This array of dynamically sized segments includes a size attribute and a trailing array of n-bit integers for each segment, as described in further detail herein. In some embodiments, a DNA sequence can be annotated with 7 unique values from set B. A size segment of 3 bits can be used to store the schema for the trailing number of index cells.

When data are string types and the mapping types data storage, are not found to be a viable option during data analysis, the analyzer can perform a further analysis on the characters used to compose the set of data. In the general case, the character encoding defaults to Universal Coded Character Set+Transformation Format-8-bit (UTF-8). An analysis can be performed on strings lengths specific to the minimum and maximum lengths of each string, producing a respective length meta-attribute. This value undergoes the same processing as the number type of data to determine the number of bits to use. When there is an especially small set of characters, a special meta-attribute encoding/mapping of characters can be derived.

For example, for string typed data, in some embodiments, the size or length of each string can be determined and then the character sequence can be dereferenced and the underlying bit value is stored in byte array. In many cases with DNA sequence annotated data, a small set of characters can be used. From the String domain analysis a character encoding can be defined and mapped (and stored in the definition of the storage scheme for the data set). This technique differs in that the mapping is performed cumulatively on the characters of the entries, instead of a mapping of the entries. In some embodiments,

A={STRING_1,STRING_2, . . . ,STRING_N},

B={x|xεSTRING_1}U{x|xεSTRING_2}U{ . . . }U{x|xεSTRING_N}

C={all characters}∩{x|xεB}≡{all unique characters that the values of A are composed of}

Take raw DNA sequence in the actual variant call as an example, for five variants, “A”, “AA”, “CA”, “TA”, “GG”:

A={“A”,“AA”,“CA”,“TA”,“GG”},

B={“A”}U{“A”}U{ . . . }U{“G”}

C={all characters}Ω{x|xεB}≡{“A”,“C”,“T”,“G”}

An index set is defined that has a bijective mapping between the index set and set C:

D={x|xεZ,0≦x≦total unique characters},

Where there exists a Bijection between set C and set D.

In these embodiments, there are three sets; the original string values (set A) and the two sets used to define a custom character encoding (set C and set D). Thus during construction of the binary object further analysis is used (e.g., by the analyzer). The analyzer analyzes set A to identify the longest string value. In this example, the longest string value is a four-way tie at two characters long. The binary storage can be constructed. First, the analyzer can determine the number of bits used to represent each character. There are four unique characters, which can be stored in 2-bit integers. This allows for values between 0 and 3. From the maximum length the analyzer can determine that each entry can start with a 2-bit integer, as described in further detail herein. This defines how many trailing 2-bit integers can be decoded using this dynamic character encoding scheme.

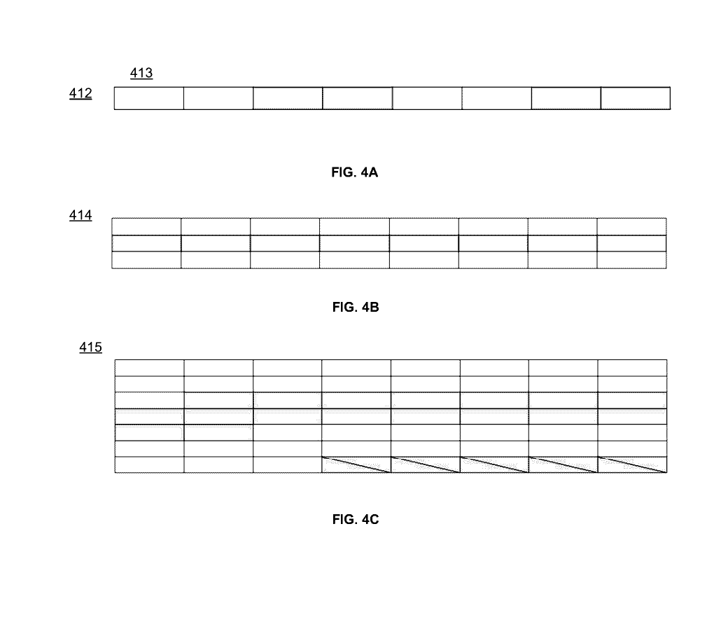

FIGS. 4A-4C are diagrams illustrating binary structures in a form of arrays implemented by a data management system, according to an embodiment. In some embodiments, a data management system can be configured to store data in as arrays in a data set. Arrays, for the purpose of storage, can have a specified size (e.g., in bytes or bits) in RAM or disk space. A Boolean array can reserve 1-bit for each cell of the array and a byte array can reserve a byte for each cell of the array. For example, an array of X cells can be defined with each cell having n-bits. FIG. 4A shows a 2-bit array of size 4 over 1 byte of memory. The row 412 represents 1 byte of memory. Each cell, e.g., 413, in the row represents 1 bit of memory. FIG. 4B shows an 8-bit array of size 3 over 3 bytes of memory 414. FIG. 4C shows a 17-bit array of size 3 over 7 bytes of memory 415. The binary structures illustrated in FIGS. 4A-4C provide base-components for data storage implemented by the data management system. The dimensions of the binary structures can be any sizes over any bytes of memory, not limited to the binary structures illustrated in FIGS. 4A-4C.

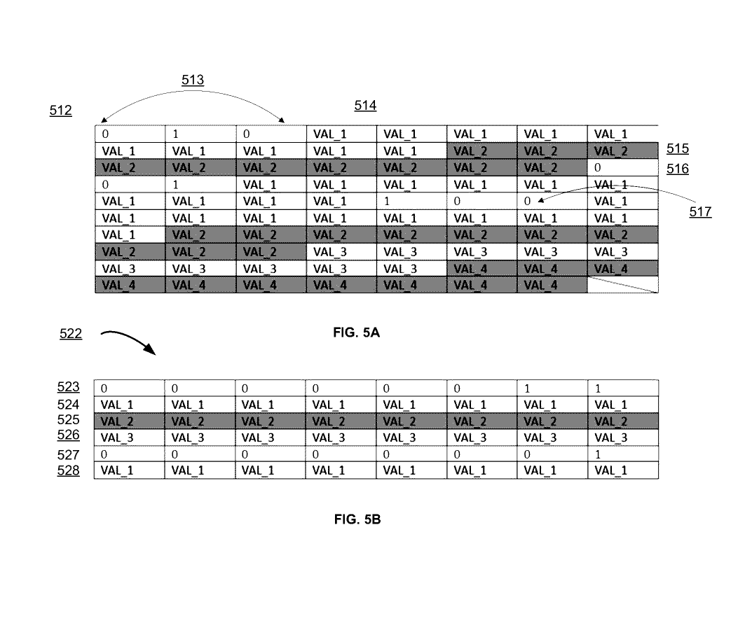

FIGS. 5A-5B are diagrams illustrating binary structures in a form of heap arrays implemented by a data management system, according to an embodiment. In some embodiments, a data management system can be configured to store data as heap arrays (i.e., differently sized arrays) in a data set. In some embodiments, the values of the set of objects are segmented into two separate values. These tuples of information are joined together. Each value for a classification parameter of the set of objects has two corresponding values, a preluding size (i.e., leading value) stored in N-bits and a trailing number of values over M-bit cells. Each leading value is followed by a value from the set of values for the classification parameter of the data set. Each leading value indicates a size of the value following that leading value. This allows the second data set to be scanned to locate a value from the set of values for the classification parameter of the second data set and associated with a particular object from the set of objects using the leading values and an order of the set of values for the classification parameter of the second data set.

FIG. 5A shows, for example, a multidimensional array of size 3 over 10 bytes 512. In this array, values associated with 3 values for a classification parameter (i.e., for three different objects) are stored in 10 bytes of storage space. The first three cells 513 indicate that the first object has 2 values for the classification parameter (shown as binary 010), VAL_1, 514, and VAL_2, 515. Each value of the first object has 10 bits of storage. The second object has 1 value for the classification parameter, 516 (shown as binary 001). Each value of the second object has 10 bits of storage. The third object has 3 values for the classification parameter, 517 (shown as binary 100). Each value of the third object has 10 bits of storage. FIG. 5B shows a multidimensional array of size 2 over 6 bytes 522. In this array, values associated with 2 objects are stored in 6 bytes of storage space. The first object has 3 values for the classification parameter of the data set, 523, followed by a first value, VAL_1 524, a second value, VAL_2 525, and a third value, VAL_3 526. Each value of the first object has 8 bits of storage. The second object has 1 value for the classification parameter of the data set, 527, followed by a first value, VAL_1 528, which has 8 bits of storage. The dimensions of the binary structures can be any sizes over any bytes of memory, not limited to the binary structures illustrated in FIGS. 5A-5B.

The binary structures illustrated in FIGS. 5A-5B allow different number of values for a classification parameter to be represented for each object. The scheme definition for a given data set can include an indication of the size of the value count and the size of the values. For example, the scheme definition for the data set 512 of FIG. 5A can indicate that 3 bits are allocated for the value count and that 10 bits are allocated for each value. The number of bits allocated to the value count determines the maximum number of values the classification parameter of an object can have (e.g., a value count of three allows each object to have up to eight values for a classification parameter). The value count and the size of the values allows index crawling when accessing data from data sets. For example, when the count is 2 (i.e., there are 2 values for the classification parameter of an object) and the number of bits for each value is known (e.g., 10 bits of storage space), the index crawler can go to the 11^{th} bit of the storage space to access the values for the classification parameter of the second object.

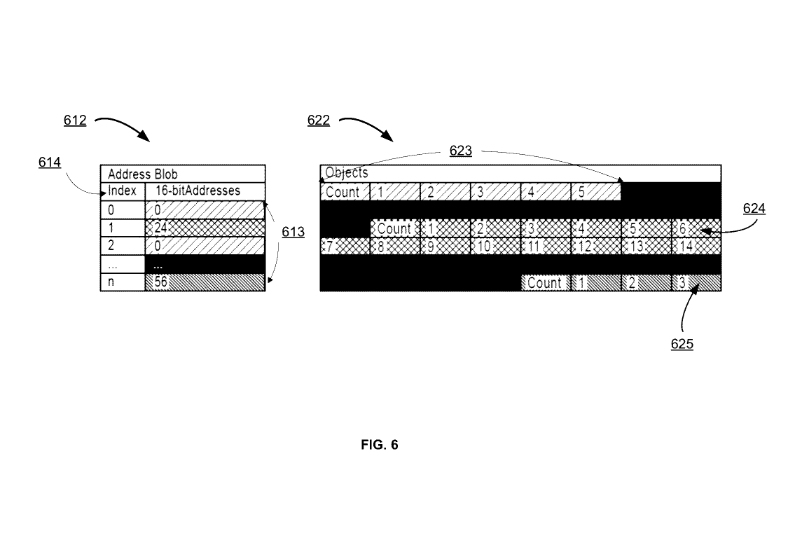

FIG. 6 is a diagram illustrating an object mapping storage structure implemented by a data management system, according to an embodiment. In some embodiments, an object map includes at least two blobs and/or data sets, an address blob or data set and an object mapping. The address blob includes a memory address (e.g., memory pointer) for the value of each object. The memory address can be structured similar to the data sets shown and described with respect to FIG. 3, with the values being memory addresses (e.g., memory pointers). Each value in the address points to a memory location at which the value for an object is stored. The address blob also includes a pseudo index for each object (which may or may not be stored). In some embodiments, the address blob includes same number of bits for each value of the address (similar to the values of the data sets of FIG. 3).

The object mapping makes use of a preliminary count cell at the target address and a trailing number of bits/bytes that store the value. In FIG. 6, the address portion 612 stores the memory location at which the value for that object is stored 613. The index column 614 is a pseudo index shown here simply to assist in the understanding, but may not exist in memory. For example, each cell in the Object mapping 622 represents one byte of storage space. For example, the object at address 0 has a count of 5, in other words, a trailing of 5 additional byte values, 623. The object at address 24 has a count of 14, a trailing of 14 byte values, 624. For another example, the object at address 56 has a count of 3 single byte values, 625. Thus, if a data management module is accessing the value for the object with index 1, the data management module will access the second 16-bit address in the address blob 612 and, using the address, access the memory location of the count for the values 624. The count indicates the number of bytes used to represent the value (e.g., 14 in this example). The value can then be retrieved from the 14 subsequent bytes in the object mapper 622 portion of the memory.

In some embodiments, the values stored in the object mapping include additional addresses into other object mapping data sets thus subsequent data retrieval can be achieved. This allows a web of connections to be made supporting compression of complex data (e.g., complex genome annotation sets).

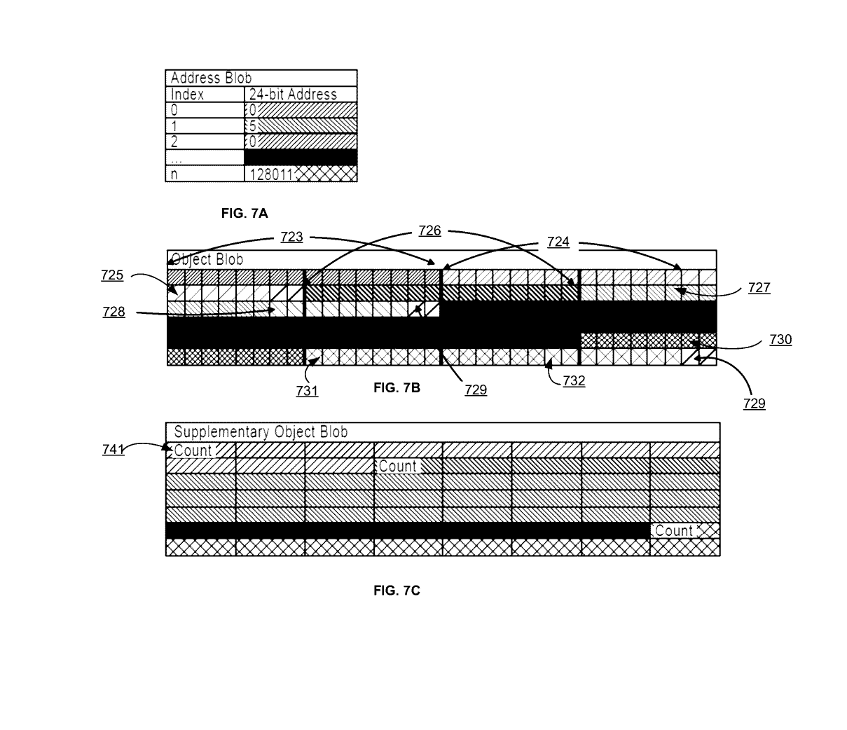

FIGS. 7A-7C are diagrams illustrating another object mapping storage structure implemented by a data management system, according to an embodiment. FIG. 7A, similar to 612 in FIG. 6, is an address blob including an address (e.g., memory pointer) of a memory location in which a value for a configuration parameter for each object is stored. Each entry points to the memory location in which the object is stored. FIG. 7B, similar to 622 in FIG. 6, shows the values associated with the objects. Each cell in FIG. 7B represents a single bit of storage space. The first 16-bit sized cells of each object 723, 726, 730, point to address values in the supplementary object blob in FIG. 7C. The first 16-bit sized cells are followed by 14-bit sized cells 724, 727, 731, followed by 8-bit sized cells 725, 728, 732. In such an example, the memory address 723, 726, 730 can allow the data management module to access a memory location in the supplementary object blob of FIG. 7C to retrieve at least a portion of the value. In addition to retrieving a portion of the value from the supplementary object blob, a second portion of the value for the classification parameter for each object can be stored in the 14-bit sized cells 724, 727, 731 and the 8-bit sized cells 725, 728, 732. Thus, a value for a classification parameter for an object can include data stored in the object blob of FIG. 7B and data stored in the supplementary object blob of FIG. 7C.

Moreover, the stored values in the object blob of FIG. 7B can be referenced by multiple objects. For example, if the value of the classification parameter for both object 0 and object 2 is the same, the memory address for each of these objects can reference the same memory location in the object blob of FIG. 7B (e.g., both can reference memory location 723). This allows the same stored value to be used as the value for the classification parameter for multiple objects. This decreases the memory used to store the values in the object blob.

In some embodiments, the bits 729, exist for padding purposes so the following objects can be initially addressed without bit-shifting. In other embodiments, these padding cells do not exist. Implementations of padding are specific to a given domain and can differ between domains.

FIG. 7C shows a supplementary object blob. In some embodiments, the supplementary object blob is a part of the object blob shown in FIG. 7B. In other embodiments, the supplementary object blob is separated from the object blob shown in FIG. 7B. The values in the supplementary object blob in FIG. 7C can be shared across multiple objects, normalizing the data. For example, both the memory address at 724 in FIG. 7B and the memory address at 726 in FIG. 7B can reference the same location in the supplementary object blob. This allows the same stored value to be used as at least a portion of the value for the classification parameter for multiple objects. This decreases the memory used to store the values in the supplementary object blob. Each cell in this table can be a single byte. In some embodiments, the initial count of bytes 741 is referenced by the address in the object blob in FIG. 7B. This count byte can be followed by 8-bit values.

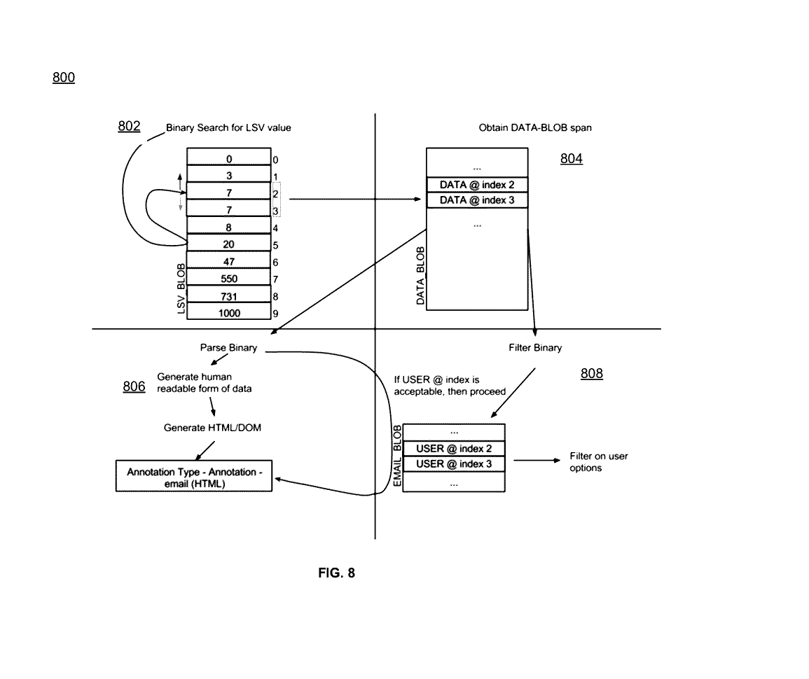

FIG. 8 is a diagram illustrating a curative data handling binary structure data access method 800 for a given object in a test deoxyribonucleic acid (DNA) sequence, according to an embodiment. In some embodiments, an analyzer and a compressor in a data management module can be configured to analyze and store curative datasets that can be updated and/or added to via input from users. Accordingly, such data sets are not static in size or value. In some embodiments, data compression can be used after new data is received. In such embodiments, the data analysis and compression can occur each time the data is updated. Thus, a new determination of the appropriate storage scheme for each classification parameter can be updated each time new data is received. In other embodiments, data compression can be used after a group of new data is received (e.g., an amount of new data above a threshold is received) and/or periodically (i.e., added based on a periodic timer).

In one example, new data can be added to the memory when annotating a test DNA sequence. Curated annotations can also be shared across DNA sequences. In some embodiments, data annotations are treated as constant, but calculated on request. Test DNA sequences with similar variant-objects can become reference DNA sequences and have their respective annotations added into the dataset specific to the test DNA sequence. In some embodiments, however, object mappings and index seeking can be used for curated annotations.

Returning to FIG. 8, a binary search method and/or algorithm can be used to access a pseudo index for an object (reference as an “LSV value”, Local Sample Variant), at 802. In other embodiments, any other method and/or algorithm can be used to access the pseudo index. Using the pseudo index for the object, data associated with that object can be accessed from a DATA_BLOB, at 804. The definition of the storage scheme for this classification parameter can be accessed and used to generate a human readable email to be sent to a user, at 806. In addition, the user identifier can be accessed using the EMAIL_BLOB, at 808. Such a user can be, for example, authenticated as being able to access this classification parameter for the object. Additionally, any user preferences and/or filters associated with that user (e.g., stored in a separate user preferences/filters data set) can be applied. An annotation email can then be sent to the user.

In some embodiments, the LSV values, at 802, are sorted in an order of ascending value (i.e., from the lowest value to the highest value). When a new annotation is created, the data structure can be extended and the LSV value data set inserts the new index in a way such that the structure keeps the LSV values in the increasing order. In other embodiments, the LSV values, at 802, can be sorted in a descending order.

In some embodiments, DATA_BLOB, at 804, can represent text annotations, raw numbers (e.g., a scale of 1 to 10 representing how interesting a variant is), and/or integer values mapped to Human-readable annotations (e.g., “Variant likely causing an impact”, or “Variant likely benign”). Each type of annotations can belong to a different grouping of sets. In this instance, there can be 3 separate LSV_VALUES segments, 3 separate DATA_BLOB segments, 3 separate EMAIL_INDEX_BLOB segments, and 1 EMAIL_BLOB. The DATA_BLOB segments can include the “text annotations”, “raw numbers” and “integer values to be mapped.” Additionally, there can be a fifth data set representing timestamps. These timestamps can be stored in the same order as the values in DATA_BLOB. For example, a value at index 2 in DATA_BLOB can have a corresponding timestamp at index 2 in the TIMESTAMP BLOB.

In some embodiments, there are two forms of annotations, including Text Type Annotations (freely written) and Flag Type Annotations (predefined responses). Both forms of curated annotations can be stored with a combination of storage schemes. These two forms of annotations can be further compartmentalized in terms of storage based on whether the individual performing the analysis created and/or defined the annotations for a given DNA sequence (Own Annotations), someone else defined the annotations for a given DNA sequence (Other Annotations), or if these annotations were defined on another DNA sequence but are relevant to the test DNA sequence (Reference Annotations).

In some embodiments, for example, there are five unique sets that compose the categories of curated annotations. These sets can include the same number of cells/values. A pseudo index can thus be assigned that is used to access data across the sets related to a type of curated data. As an example, the following five sets can be referenced in the varying sets of annotations:

A={x|xεZ,0≦x≦Number of Variants}≡{Pseudo Variant-Object Indexes}

B={Annotation Values}≡{x|xεZ,0≦x≦Number of Flag Options}U{Text values}

C={x|xεZ,0≦x≦TIME_IN_SECONDS}≡{Timestamps}

D={User Identifier}

E={x|xεZ}≡{User Address Blob}

With the Own Annotations that are text based, in some embodiments, there are three underlying storages on disk space. Abstractly Set A, Set B, and Set C compose the own text annotations. The first, set A can be, for example, an array of 32-bit sized cells containing LSV (Local Sample Variant-Object) Indexes. The Second set, can be, for example, a pattern delimited text file. A pattern can be used because the nature of the annotations contains the common delimiters, such as commas, newlines, tabs, quotes, etc. The third set can be a grouping of timestamps representing the time the text annotation was made.

In some embodiments, Other Annotations that are text based can be represented similar to the Own Annotations that are text based, with the exception being that an additional set of data, Set D, is used. Set D in this case is composed of user ID's. Part of the schema defines the mapping between user name and user ID.

In some embodiments, Reference Annotations can be represented similar to the Own Annotations. The Reference Annotations can also have a User Identifier set, however this set can be additionally an address set into a fifth set, an email address set.

Flagged Annotations can be stored similar to map and set annotations (e.g., the object mapping storage structures as described with respective to FIG. 6A and FIGS. 7A-7C). In some embodiments, a “flagged annotation” can be a Boolean flag. In some instances, it can be an integer key representing a pre-determined response. This integer value can be encoded to its respective pre-determined response when it is processed to be displayed.

Similar to the text annotations these flagged annotations can be stored in sorted structures, similar to the ascending structures of the LSV values at 802. The Own Annotations that are flagged based can be, for example, stored in three sets, Set A, Set B, and set C, similar to the text annotations. The binary values, however, represent the flag options (e.g., binary flag options) instead of text values. Other Flagged annotations are akin to own flagged annotations except that an additional set of data representing the author can be added. For example, Set D, a set composed of user ID's can be added.

Reference Annotations that are flagged based are similar to Own Annotations that are flagged based. Such Reference Annotations also have a set of user Identifiers. Such Reference Annotations can also include a fifth set; an email set.

The previous discussions can be the building blocks that can be used in combination in order to construct more complex data structures. There are several sets that use combinations of the previously discussed techniques. Some of these data sets include specific genomic medicine use case datasets such as Transcripts and ClinVar. These datasets can be used as examples in order to discuss such combinations. In an example Transcript Annotation Set, transcripts can be composed of a prefix mapping trailed by an underscore, then a number signifying an ID, a period and lastly a version number:

<PREFIX>_<ID>.<VERSION>

In some instances, the underscore and the period are shared across values and can be used in the schema declaration. An analysis of the prefix can be done on the domain for a mapping/set. The ID field can be broken down into a number, integer type and the same can be said for the version. In other instances, the transcript can be broken down into 2 separate fields, the prefix being reduced to a mapping/set and the ID and Version combined to make a number/float type data set. In still other instances, the three components can be joined together in a single blob using the techniques described herein. In this instance, each variant-object record can be indexed integer arrays of set cell size.

ClinVar is an archive of reports of the relationships among human variations and phenotypes. Below is an example of how a ClinVar record can be stored and/or represented using the techniques described herein.

In the ClinVar example,

ClinVar Records≡{x|xεGenotype}∩{x|xεReview Date}∩{x|xεAccession ID}∩{x|xεAccession Version}∩{x|xεReview Status}∩{x|xεClassification}∩{x|xεClassification Submission Count}∩{x|xεTrait}∩{x|xεPubMed Supporting Evidence}∩{x|xεOmim Allele Link}

Each composing set can be analyzed:

Genotype≡{“Single Allele Involved”,“Multiple Alleles Involved”}

Review Date≡{x|xεZ,0≦x≦CURRENT_TIME_IN_DAYS}

Accession ID≡<RCV><ID>≡{“RCV”}∩{ID εZ,0≦ID≦999999999}

Accession Version≡{x|xεZ,0≦x≦255}

Review Status≡{“reviewed by professional society”,“not classified by submitter”,“classified by multiple submitters”,“reviewed by expert panel”,“classified by single submitter”}

Classification≡{“protective”,“other”,“not provided”,“association”,“Likely pathogenic”,“Uncertain significance”,“Likely benign”,“drug response”,“Benign”,“Pathogenic”,“risk factor”,“confers sensitivity”}

Classification Submission Count≡{x|xεZ,0≦x≦255}

PubMed Supporting Evidence≡{URL}

OMIM Allele Link≡{URL}

Trait can be broken down as follows:

Trait≡{x|xεType}∩{x|xεName}∩{x|xεPubMed Reference}∩{x|xεMedGen Reference}∩{x|xεMode of Inheritance}∩{x|xεOMIM Reference}∩{x|xεDefinition}

Each subset can be subsequently analyzed:

Type≡{“Drug Response”,“Named Protein”,“Finding”,“Disease”,“Blood group”}

Name≡{UTF-8 Characters}

PubMed Reference≡{URL}

MedGen Reference≡{URL}

Mode of Inheritance≡{“Not Available”,“Autosomal recessive inheritance”,“X-linked inheritance”,“Sporadic”,“Sex-limited autosomal dominant”,“Autosomal dominant inheritance”,“X-linked dominant inheritance”,“Other”,“Mitochondrial inheritance”,“Autosomal unknown”,“X-linked recessive inheritance”,“Codominant”,“Somatic mutation”}

OMIM Reference≡{URL}(Online Mendelian Inheritance in Man (OMIM))

Definition≡{UTF-8 Characters}

With these definitions sets/domains can be defined to generate an underlying binary structure. After the initial ClinVar analysis, in one embodiment, this structure can be constructed in the binary through construction of four data sets. The first data set can include a Uniform Resource Locator (URL) mapping for the URL values. This first data set, can be a 16-bit size value at a given address followed by the trailing number UTF-8 values.

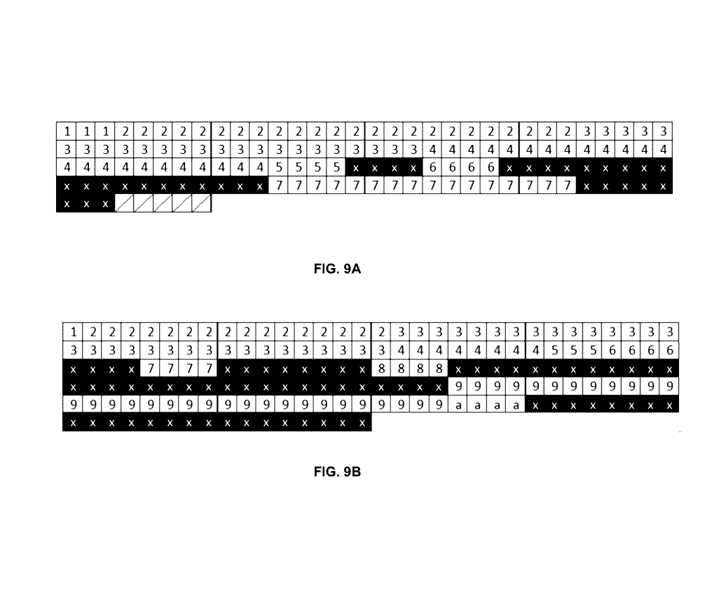

The second data set consists of Trait records with the binary representation illustrated in FIG. 9A, in bits. FIG. 9A is a diagram illustrating a value for each trait record, according to an embodiment. In FIG. 9A, 1 is Type value storage, 2 is Name value storage, 3 is PubMed Reference storage, 4 is MedGen Reference storage, 5 is Mode of Inheritance count storage followed by 4-bit Mode of Inheritance values, 6 is Omim Reference count storage followed by 20-bit Omim IDs, 7 is Definition character counts followed by 8-bit UTF-8 values. The x's are the trailing/repeatable values for the preceding number.

The third data set consists of ClinVar records with the binary representation illustrated in FIG. 9B. FIG. 9B is a diagram illustrating a value for each ClinVar record, according to an embodiment. In FIG. 9B, 1 is Genotype Storage, 2 is Review Date Storage, 3 is Accession ID Storage, 4 is Accession Version Storage, 5 is Review Status Storage, 6 is Classification Storage counts followed by 4-bits per Classification, 7 is Classification Submission counts followed by 8-bits per Submission value, 8 is Trait Addresses counts followed by 32-bit addresses into the Trait Blob, 9 is PubMed Address value into a URL blob, a is OMIM Allele Link Address counts followed by 24-bit addresses. The x's are the trailing/repeatable values for the preceding number.

The fourth data set can be what maps the variant-objects to the ClinVar records. This can be an 8-bit number of record values trailed by 24-bit addresses into the ClinVar Records blob (e.g., a pointer into the ClinVar third data set).

Using these four data sets, objects for the ClinVar records can be stored and/or retrieved by a data management module.

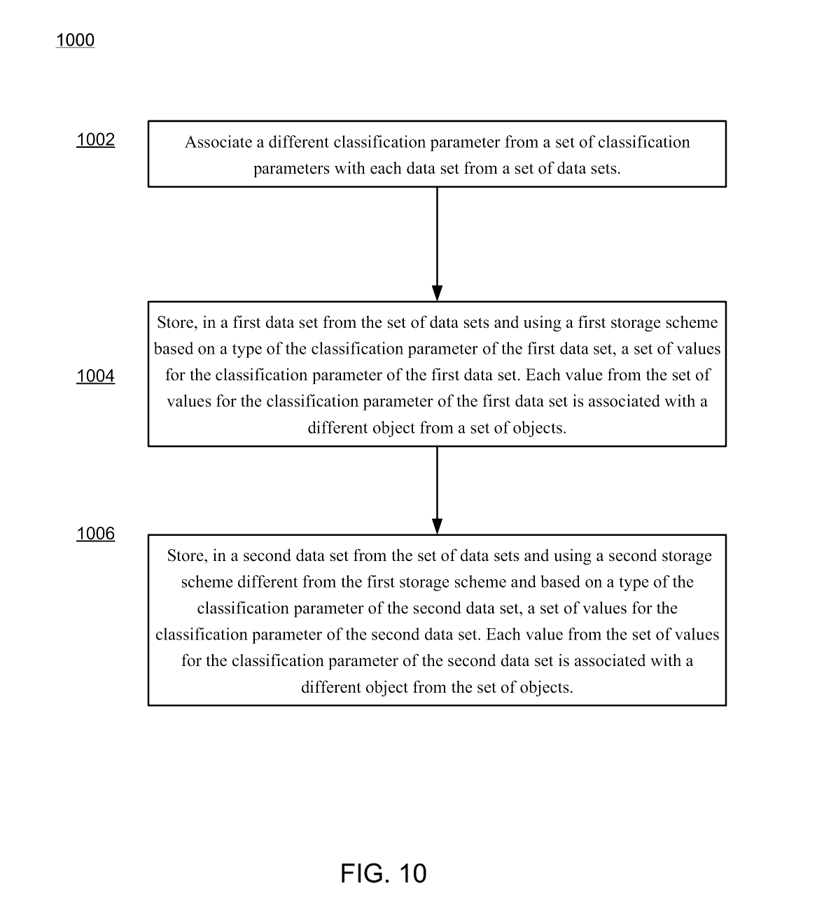

FIG. 10 is a flow chart illustrating a data management method, according to an embodiment. The data management method 1000 can be executed at, for example, a data management module such as the data management module 230 shown and described with respect to FIG. 2. The data management module can include, for example, an analyzer and a compressor, which are similar to the components of the data management module 230 shown and described with respect to FIG. 2. An analyzer in the data management module is configured to associate a different classification parameter from a set of classification parameters with each data set from a set of data sets stored in the memory at 1002. A compressor in the data management module is configured to store, in a first data set from the set of data sets and using a first storage scheme based on a type of the classification parameter of the first data set, a set of values for the classification parameter of the first data set at 1004. Each value from the set of values for the classification parameter of the first data set can be associated with a different object from a set of objects. The compressor in the data management module is configured to store, in a second data set from the set of data sets and using a second storage scheme different from the first storage scheme and based on a type of the classification parameter of the second data set, a set of values for the classification parameter of the second data set at 1006. Each value from the set of values for the classification parameter of the second data set can be associated with a different object from the set of objects.

While described above as being used to store genomic variant and annotation data, in other embodiments any other suitable data can be stored using the data sets and storage schemes described herein. For example, medical records, student records, legal contracts, financial data, geographic maps and/or the like can be stored using the methods and data structures described herein. Such data can be analyzed and classified according to type (e.g., different classification parameters for different data in each object) and then stored across different data sets using different storage schemes identified for the specific types/classification parameters.

It is intended that the systems and methods described herein can be performed by software (stored in memory and/or executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including Unix utilities, C, C++, Java™, JavaScript (e.g., ECMAScript 6), Ruby, SQL, SAS®, the R programming language/software environment, Visual Basic™, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

Some embodiments described herein relate to devices with a non-transitory computer-readable medium (also can be referred to as a non-transitory processor-readable medium or memory) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein. Each of the devices described herein, for example, nodes 462, 464, 466 and 468, other nodes, servers and/or switches, etc can include one or more memories and/or computer readable media as described above.

While various embodiments have been described above, it should be understood that they have been presented by way of example only, and not limitation. Where methods and steps described above indicate certain events occurring in certain order, the ordering of certain steps may be modified. Additionally, certain of the steps may be performed concurrently in a parallel process when possible, as well as performed sequentially as described above. Although various embodiments have been described as having particular features and/or combinations of components, other embodiments are possible having any combination or sub-combination of any features and/or components from any of the embodiments described herein. Furthermore, although various embodiments are described as having a particular entity associated with a particular compute device, in other embodiments different entities can be associated with other and/or different compute devices.

What is claimed is:

1. An apparatus, comprising:
a data management module implemented in at least one of a memory or a processor, the data management module configured to associate a different classification parameter from a plurality of classification parameters with each data set from a plurality of data sets stored in the memory,
the data management module configured to store, in a first data set from the plurality of data sets and using a first storage scheme based on a type of the classification parameter of the first data set, a set of values for the classification parameter of the first data set,
each value from the set of values for the classification parameter of the first data set being associated with a different object from a plurality of objects,
the data management module configured to store, in a second data set from the plurality of data sets and using a second storage scheme different from the first storage scheme and based on a type of the classification parameter of the second data set, a set of values for the classification parameter of the second data set,
each value from the set of values for the classification parameter of the second data set being associated with a different object from the plurality of objects.

2. The apparatus of claim 1, wherein the data management module is configured to collectively store in the plurality of data sets a set of values for each object from the plurality of objects based on the plurality of classification parameters.

3. The apparatus of claim 1, wherein the set of values for the classification parameter of the first data set and the set of values for the classification parameter of the second data set are stored such that an order in the first data set of the value associated with each object from the plurality of objects is the same as an order in the second data set of the value associated with that object from the plurality of objects in the second data set.

4. The apparatus of claim 1, wherein the data management module is configured to store a plurality of leading values in the second data set from the plurality of data sets,
each leading value from the plurality of leading values (1) being followed by a value from the set of values for the classification parameter of the second data set and (2) indicating a size of the value following that leading value from the plurality of leading values, such that the second data set can be scanned to locate a value from the set of values for the classification parameter of the second data set and associated with a particular object from the plurality of objects using the plurality of leading values and an order of the set of values for the classification parameter of the second data set.

5. The apparatus of claim 1, wherein each value from the set of values for the classification parameter of the first data set is a first value that points to a memory location of a second value associated with the object from the plurality of objects associated with the first value.

6. The apparatus of claim 1, wherein the plurality of classification parameters includes at least one of numbers, dates, names, or strings.

7. The apparatus of claim 1, wherein the plurality of objects includes at least one of genomic information, biomedical data, biological data, phenotype data, sequencing derived data, publications, medical records, student records, legal contracts, financial data, or geographic maps.

8. The apparatus of claim 1, wherein the data management module is configured to assign a range with a minimum value and a maximum value to the first data set from the plurality of data sets such that a value, from the set of values for the classification parameter of the first data set, outside the range can be normalized based on the range.

9. An apparatus, comprising:
a data management module implemented in at least one of a memory or a processor, the data management module configured to associate a different classification parameter from a plurality of classification parameters with each data set from a plurality of data sets stored in a database,
the data management module configured to store, in a first data set from the plurality of data sets, a set of values for the classification parameter of the first data set,
each value from the set of values for the classification parameter of the first data set being associated with a different object from a plurality of objects,
the data management module configured to store, in a second data set from the plurality of data sets, a set of values for the classification parameter of the second data set,
each value from the set of values for the classification parameter of the second data set being associated with a different object from the plurality of objects,
an order in the first data set of the value associated with each object from the plurality of objects is the same as an order in the second data set of the value associated with that object from the plurality of objects.

10. The apparatus of claim 9, wherein the data management module is configured to collectively store in the plurality of data sets a set of values for each object from the plurality of objects based on the plurality of classification parameters.

11. The apparatus of claim 9, wherein the set of values for the classification parameter of the first data set are stored in the first data set from the plurality of data sets using a first storage scheme based on a type of the classification parameter of the first data set,
the set of values for the classification parameter of the second data set are stored in the second data set from the plurality of data sets using a second storage scheme different from the first storage scheme based on a type of the classification parameter of the second data set,

12. The apparatus of claim 9, wherein the data management module is configured to store a plurality of leading values in the second data set from the plurality of data sets,
each leading value from the plurality of leading values (1) being followed by a value from the set of values for the classification parameter of the second data set and (2) indicating a size of the value following that leading value from the plurality of leading values, such that the second data set can be scanned to locate a value from the set of values for the classification parameter of the second data set and associated with a particular object from the plurality of objects using the plurality of leading values and an order of the set of values for the classification parameter of the second data set.

13. The apparatus of claim 9, wherein each value from the set of values for the classification parameter of the first data set is a first value that points to a memory location of a second value associated with an object from the plurality of objects and associated with that value from the set of values for the classification parameter of the first data set.

14. The apparatus of claim 9, wherein the plurality of classification parameters includes at least one of numbers, dates, names, or strings.

15. The apparatus of claim 9, wherein the plurality of objects includes at least one of genomic sequences, medical records, student records, legal contracts, financial data, or geographic maps.

16. A non-transitory processor-readable medium storing code representing instructions to be executed by a processor, the code comprising code to cause the processor to:
associate a different classification parameter from a plurality of classification parameters with each data set from a plurality of data sets;
store, in a first data set from the plurality of data sets and using a first storage scheme based on a type of the classification parameter of the first data set, a set of values for the classification parameter of the first data set,
each value from the set of values for the classification parameter of the first data set being associated with a different object from a plurality of objects; and
store, in a second data set from the plurality of data sets and using a second storage scheme based on a type of the classification parameter of the second data set, a set of values for the classification parameter of the second data set,
each value from the set of values for the classification parameter of the second data set being associated with a different object from the plurality of objects.

17. The non-transitory processor-readable medium of claim 16, further comprising code to cause the processor to:
collectively store in the plurality of data sets a set of values for each object from the plurality of objects based on the plurality of classification parameters.

18. The non-transitory processor-readable medium of claim 16, wherein the set of values for the classification parameter of the first data set and the set of values for the classification parameter of the second data set are stored such that an order in the first data set of the value associated with each object from the plurality of objects is the same as an order in the second data set of the value associated with that object from the plurality of objects in the second data set.

19. The non-transitory processor-readable medium of claim 16, wherein each data set from the plurality of data sets is in a form of array with a plurality of cells, each cell from the plurality of cells representing a byte in memory.

20. The non-transitory processor-readable medium of claim 16, wherein the plurality of classification parameters includes at least one of numbers, dates, names, or strings.

21. The non-transitory processor-readable medium of claim 16, further comprising code to cause the processor to:
retrieve, from the first data set, a first value associated with a target object from the plurality of objects based on a predefined position of the target object in an order of the plurality of objects; and
retrieve, from the second data set, a second value associated with the target object based on the predefined position of the target object in the order of the plurality of objects.
